(19) United States
(12) Patent Application Publication
(10) Pub. No.: US 2019/0015853 A1
(43) Pub. Date: Jan. 17, 2019

(54) PRESSURE WASHER SPRAY GUN WITH MULTIPLE CHEMICAL CONTAINERS

(71) Applicant: Briggs & Stratton Corporation, Wauwatosa, WI (US)

(72) Inventors: Todd W. Johnson, Wauwatosa, WI (US); Matthew S. Zurawski, Whitewater, WI (US); Christopher M. Krajewski, West Allis, WI (US); Ryan T. Hahn, Wauwatosa, WI (US)

(73) Assignee: Briggs & Stratton Corporation, Wauwatosa, WI (US)

(21) Appl. No.: 16/070,265

(22) PCT Filed: Jan. 12, 2017
(86) PCT No.: PCT/US17/13145

§ 371 Date: Jul. 13, 2018

Related U.S. Application Data
(60) Provisional application No. 62/279,518, filed on Jan. 15, 2016.

(51) Int. Cl. B05B 7/04; B05B 7/24; B05B 7/32; B05B 9/01

(52) U.S. Cl. CPC B05B 7/0408; B05B 9/01; B05B 7/32; B05B 7/2472

(57) ABSTRACT

A spray gun for use with a pressure washer includes a spray gun body, an inlet, a primary flow path for conducting a primary fluid flow, a secondary flow path for conducting a secondary fluid flow, and an inlet flow path for receiving a flow of pressurized water from the pressure washer via the inlet. The inlet flow path directs the pressurized water into the primary flow path. The spray gun further includes multiple chemical containers carried on the spray gun body, each chemical container configured to contain a different chemical, and a selector valve movable among a number of positions to fluidly couple one of the chemical containers with the secondary flow path.

### CROSS-REFERENCE TO RELATED APPLICATIONS

This application claims priority to U.S. Provisional Patent Application No. 62/279,518, filed Jan. 15, 2016, which is incorporated herein by reference in its entirety.

### BACKGROUND

Pressure washers, powered either by an internal combustion engine or an electric motor, are commonly used for cleaning applications that require high-pressure spray, such as car washing, concrete washing, etc. While some cleaning applications require only a high-pressure water spray, others are helped by a combination of an injected chemical solution and a high-pressure water spray. This chemical injection is often achieved at or near the pump of the pressure washer, wherein the chemical is in liquid form and distributed from liquid tanks on board the pressure washer frame. There may only be a single chemical tank available to the user, or there may be multiple chemical tanks available, enabling the user to place different chemicals in different tanks and select the chemical to be used based on the desired application. However, the user must still manually switch the chemical tanks to be used, and they can only do so by returning to the pressure washer unit. This can be inconvenient for the user if their cleaning task requires multiple chemical solutions to complete, such as car wash applications with various underbody washes, protective coatings, etc.

While most chemical injection systems utilize liquid tanks on board the pressure washer frame some spray guns include a single chemical injection container mounted to a portion of the gun. However, in order for the user to change between different chemical solutions, the user must either change the chemical injection container carried on the gun or change the chemical solution in the container. This arrangement results in the user needing to stop his task, shut down the pressure washer, remove the current container, retrieve the desired container, mount the desired container, and restart the pressure washer. Accordingly, it would be advantageous to have a pressure washer spray gun with the ability to change solutions for chemical injection without the need for changing chemical tanks either at the gun or at the pressure washer frame.

### SUMMARY

One embodiment of the invention relates to a spray gun for use with a pressure washer. The spray gun includes a spray gun body, an inlet, a primary flow path for conducting a primary fluid flow, a secondary flow path for conducting a secondary fluid flow, and an inlet flow path for receiving a flow of pressurized water from the pressure washer via the inlet. The inlet flow path directs the pressurized water into the primary flow path. The spray gun further includes multiple chemical containers carried on the spray gun body, each chemical container configured to contain a different chemical, and a selector valve movable among a number of positions to fluidly couple one of the chemical containers with the secondary flow path.

Another embodiment of the invention relates to a spray gun for use with a pressure washer. The spray gun includes an inlet conduit configured to connect an inlet of the spray gun to the pressure washer to receive a pressurized water flow, a primary flow path for conducting a primary fluid flow, a secondary flow path for conducting a secondary fluid flow, and an inlet flow path for receiving a flow of pressurized water from the pressure washer via the inlet. The inlet flow path directs the pressurized water into the primary flow path. The spray gun further includes multiple chemical containers, each chemical container containing a different chemical, a nozzle including a primary flow path outlet where the primary fluid flow exits the primary flow path, and a venturi. The venturi includes a water inlet fluidly coupled to the primary flow path, a chemical inlet fluidly coupled to the secondary flow path, and an outlet, wherein the primary fluid flow and the secondary fluid flow are mixed upstream of the outlet. The spray gun further includes a chemical selector including multiple chemical containers and a selector valve including a chemical outlet fluidly coupled to the chemical inlet of the venturi. The selector valve is movable between multiple positions to fluidly couple one of the chemical containers with the chemical outlet.

Another embodiment of the invention relates to a spray gun for use with a pressure washer. The spray gun includes an inlet; a primary flow path for conducting a primary fluid flow, a secondary flow path for conducting a secondary fluid flow and an inlet flow path for receiving a flow of pressurized water from the pressure washer via the inlet. The inlet flow path splits into the primary flow path and the second flow path. The second flow path includes a pressure regulator to reduce the pressure of the secondary fluid flow to a pressure below that of the primary fluid flow. The second flow path includes a venturi for adding chemicals from a chemical source to the secondary fluid flow. The spray gun further includes a nozzle including a primary flow path outlet where the primary fluid flow exits the spray gun and a secondary flow path outlet where the secondary fluid flow exits the spray gun.

Another embodiment of the invention relates to a spray gun for use with a pressure washer. The spray gun includes a flow splitter including an inlet, a first outlet, and a second outlet, an inlet conduit configured to connect the inlet of the flow splitter to the pressure washer to receive a pressurized water flow, a nozzle including a primary water flow outlet and a secondary flow outlet, a primary water flow conduit connecting the first outlet of the flow splitter to the primary water flow outlet of the nozzle to conduct a primary water flow of pressurized water, and a pressure regulator fluidly coupled to the second outlet of the flow splitter. The pressure regulator is configured to reduce the pressure of a secondary water flow of pressurized water to a pressure below that of the primary water flow. The spray gun further includes a venturi, a chemical selector, and a secondary fluid flow conduit. The venturi includes a water inlet, a chemical inlet, and an outlet. The water inlet is fluidly coupled to the pressure regulator to receive the secondary water flow. The chemical selector includes a housing having multiple of chambers, multiple chemical containers, each positioned within one of the chambers, and a base including a chemical outlet fluidly coupled to the chemical inlet of the venturi. The housing is movable relative to the base to fluidly couple one of the chemical containers with the chemical outlet. The secondary fluid flow conduit connects the outlet of the venturi to secondary flow outlet of the nozzle.

Another embodiment of the invention relates to an accessory for a pressure washer. The accessory includes a fluid inlet for receiving a fluid, a fluid outlet for discharging the fluid, and at least one chemical pack receptacle. At least a portion of the fluid goes through the at least one chemical pack receptacle and is subsequently discharged from the accessory.

Another embodiment relates to a pressure washer gun for use with a pressure washer, the pressure washer gun suited for cleaning a vehicle. The pressure washer gun includes a fluid inlet for receiving a fluid, a fluid outlet for discharging the fluid, and at least two chemical pack receptacles. Each of the at least two chemical pack receptacles are accessible by a user to selectively deposit a chemical pack into a respective chemical pack receptacle. At least a portion of the fluid goes through a user-selected chemical pack receptacle. The at least a portion of the fluid is configured to entrain a portion of the chemical contained in the chemical pack. The at least a portion of the fluid and a portion of the chemical contained in the chemical pack are subsequently discharged from the pressure washer gun.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a rear perspective view of a pressure washer including multiple chemical tanks, according to an exemplary embodiment.

FIG. 2 is a top perspective view of a spray gun for the pressure washer of FIG. 1, according to an exemplary embodiment.

FIG. 3 is a side view of the spray gun of FIG. 2 with the outer housing removed to show the internal components, according to an exemplary embodiment.

FIG. 4 is a detail side view of the rear portion of the spray gun of FIG. 2 with the outer housing removed to show the internal components, according to an exemplary embodiment.

FIG. 5 is a cross-section view of the rear portion of the spray gun of FIG. 4, according to an exemplary embodiment.

FIG. 6 is a cross-section view of a flow control valve for the spray gun of FIG. 2 in a closed position, according to an exemplary embodiment.

FIG. 7 is a cross-section view of a flow control valve for the spray gun of FIG. 2 in an open position, according to an exemplary embodiment.

FIG. 8 is a detail side view of a chemical supply system of the spray gun of FIG. 2 with the outer housing removed to show the internal components, according to an exemplary embodiment.

FIG. 9 is a cross-section view of the chemical supply system of FIG. 8, according to an exemplary embodiment.

FIG. 10 is a cross-section view of a selector of the chemical supply system of FIG. 8, according to an exemplary embodiment.

FIG. 11 is a cross-section view of a venturi pump of the spray gun of FIG. 2, according to an exemplary embodiment.

FIG. 12 is a detail side view of a spray nozzle of the spray gun of FIG. 2, according to an exemplary embodiment.

FIG. 13 is a cross-section view of the spray nozzle of FIG. 12, according to an exemplary embodiment.

FIG. 14 is a perspective view of the spray nozzle of FIG. 12, according to an exemplary embodiment.

FIG. 15 is a perspective view of a receptacle for the chemical supply system, according to an exemplary embodiment.

FIG. 16 is a cross-section view of the receptacle of FIG. 15, according to an exemplary embodiment.

FIG. 17 is a perspective view of the chemical supply system of the spray gun of FIG. 2, according to an exemplary embodiment.

FIG. 18 is an illustration of a spray gun including a chemical supply system according to another exemplary embodiment.

FIG. 19 is an illustration of a spray gun including a chemical supply system according to another exemplary embodiment.

FIG. 20 is an illustration of chemical packs for use with the chemical supply systems of FIGS. 18 and 19, according to another exemplary embodiment.

FIG. 21 is a side view of a spray gun, according to another exemplary embodiment.

FIG. 22 is a side view of the spray gun of FIG. 21 with the outer housing removed to show the internal components, according to another exemplary embodiment.

FIG. 23 is an illustration of a venturi of the spray gun of FIG. 21, according to another exemplary embodiment.

FIG. 24 is a side view of the spray gun of FIG. 21, according to another exemplary embodiment.

FIG. 25 is a detailed side view of the chemical supply system of the spray gun of FIG. 21, according to another exemplary embodiment.

FIG. 26 is a detailed side view of the chemical supply system of the spray gun of FIG. 21, according to another exemplary embodiment.

FIG. 27 is a detailed side view of the chemical supply system of the spray gun of FIG. 21, according to another exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

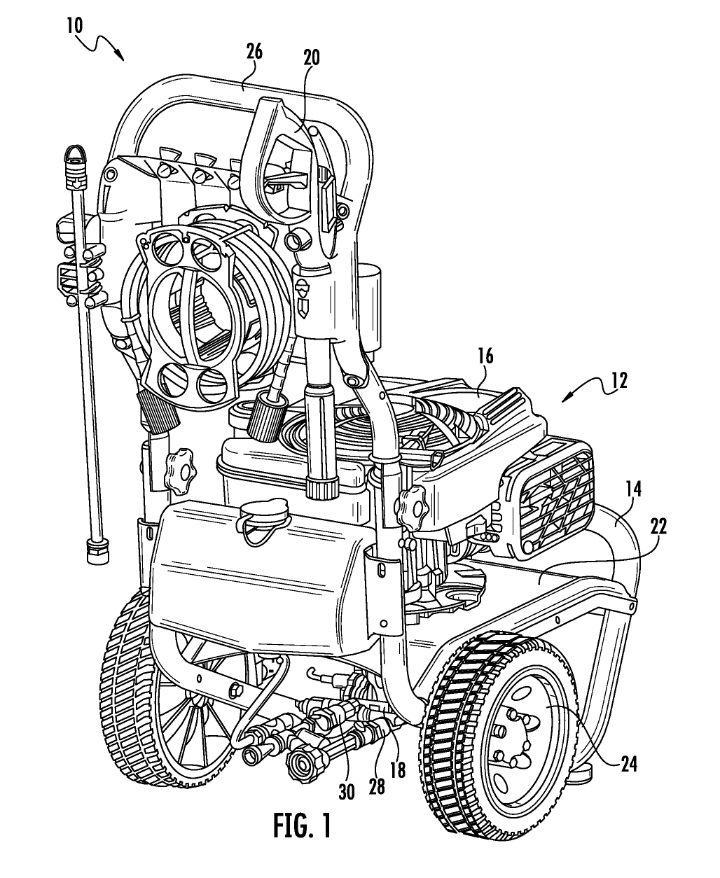

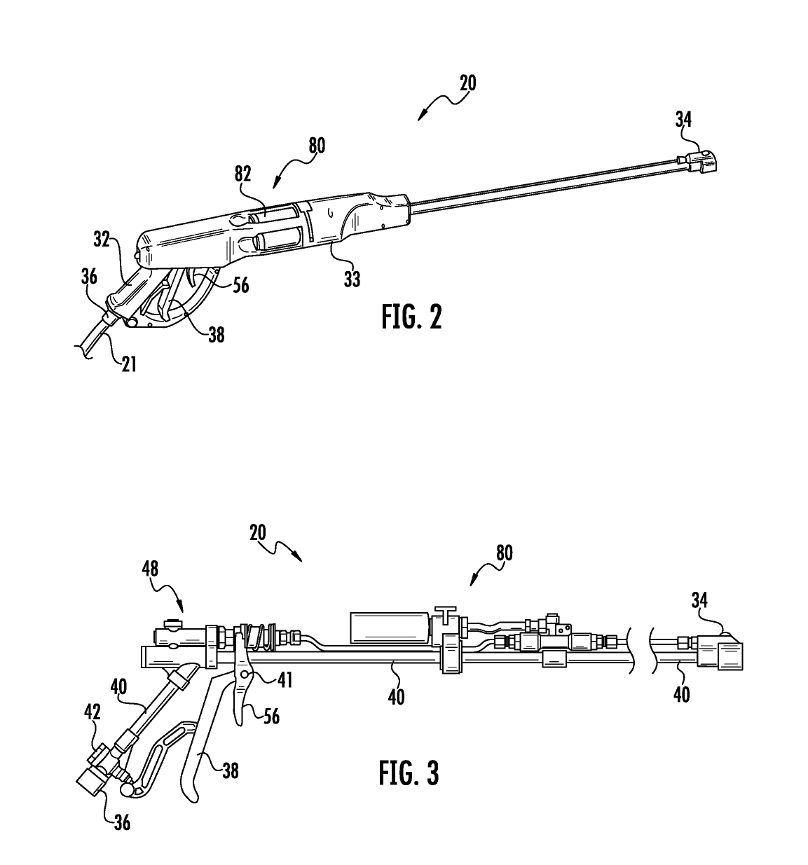

Referring to FIG. 1, a pressure washer 10 includes a base unit 12 with a frame 14 supporting a prime mover 16, such as an internal combustion engine or an electric motor, and a water pump 18 (e.g., positive displacement pump, piston water pump, axial cam pump). The pressure washer 10 further includes a spray gun 20 that is coupled to the water pump 18 with a delivery conduit 21 (e.g., a high-pressure hose) (see FIG. 2). In other embodiments, an electric motor is used as the prime mover 16. In some embodiments, the prime mover 16 is fastened to the top of a base plate 22 of the frame 14 and the water pump 18 is mounted below the base plate 22 and connected to a power takeoff of the prime mover 16 via a hole through the base plate 22. In other embodiments, the water pump is directly coupled to and supported by the engine or prime mover. The water pump 18 is coupled (e.g., directly coupled, indirectly coupled by a transmission, belts, gears, or other drive system) to the prime mover 16 to be driven by the prime mover 16. In some embodiments, the pressure washer 10 is portable and includes wheels 24 and a handle 26. In other embodiments, the pressure washer 10 may be stationary. In other embodiments, the pressure washer 10 is mounted to a trailer or other vehicle. The water pump 18 includes a pump inlet 28 and a pump outlet 30. The pump inlet 28 is configured to be coupled to a supply conduit or hose, which is in turn connected to a fluid supply (e.g., a spigot connected to a municipal water supply or well). In some embodiments, the pump inlet 28 includes a low-pressure, garden-hose style fitting for coupling a garden hose to the pump inlet 28. The pump outlet 30 includes a high-pressure fitting (e.g., an M22 fitting) for coupling the pump outlet 30 to the delivery conduit 21 or other device including an appropriate high pressure fitting. As shown in FIG. 1, pressure washer 10 uses a vertical shaft engine. According to an alternative embodiment, the prime mover may be a horizontal shaft engine.

Referring now to FIG. 2, the spray gun 20 is shown according to an exemplary embodiment to include a handle 32 and a nozzle 34. High pressure water is provided to the spray gun 20 from the pump outlet 30 through the delivery conduit 21, which is coupled to the spray gun 20 via an inlet 36. The inlet 36 may be a threaded fitting, such as a high-pressure fitting (e.g., an M22 fitting). The stream of water output from the nozzle 34 can be started or stopped by a user applying pressure to a trigger 38. The spray gun 20 allows the user to manage the direction of the stream of water independent of the location and orientation of the base unit 12 and the duration of the stream of water. The spray gun 20 may be configured to be grasped with two hands, with one hand being placed on the handle 32 and a second hand being placed on a grip portion provided by a body 33 (e.g., barrel, housing, etc.). The grasping of the spray gun 20 with two hands allows a user to have greater control of the stream of water expelled from the nozzle 34.

In some embodiments, the pressure washer 10 may further include a chemical supply system 80 that is configured to selectively introduce chemicals into the water stream provided by the spray gun 20. In some embodiments, a liquid chemical may be configured for cleaning and/or conditioning various surfaces. For example, the liquid chemical may be a presoak, detergent, soap, rinse, or wax for a vehicle. In other embodiments, the chemical may be any chemical that may be advantageously mixed with the water stream and delivered with the pressure washer, such as a fertilizer for lawn care, a pesticide, an herbicide, etc. Other uses include cleaning decks, house sidings, and driveways.

Referring now to FIG. 3, the internal components of the spray gun 20 are shown according to an exemplary embodiment. The water passes from the inlet 36 to the nozzle 34 through an internal conduit 40. The passage of water is controlled by a flow-control valve 42 that is coupled to and controlled by the trigger 38 or other user input (e.g., trigger, button, switch, dial, touch screen, etc.). The trigger 38 is configured to pivot about a pivot point 41. The flow-control valve 42 is configured to be opened when the user pulls the trigger 38 towards the handle 32, allowing the water to flow through the conduit 40 to be expelled through the nozzle 34, and closed when the trigger 38 is released. The trigger 38 may be biased towards the closed position by a biasing element, such as a torsion spring. The spray gun 20 may further include a locking device to prevent the trigger 38 from being inadvertently pulled.

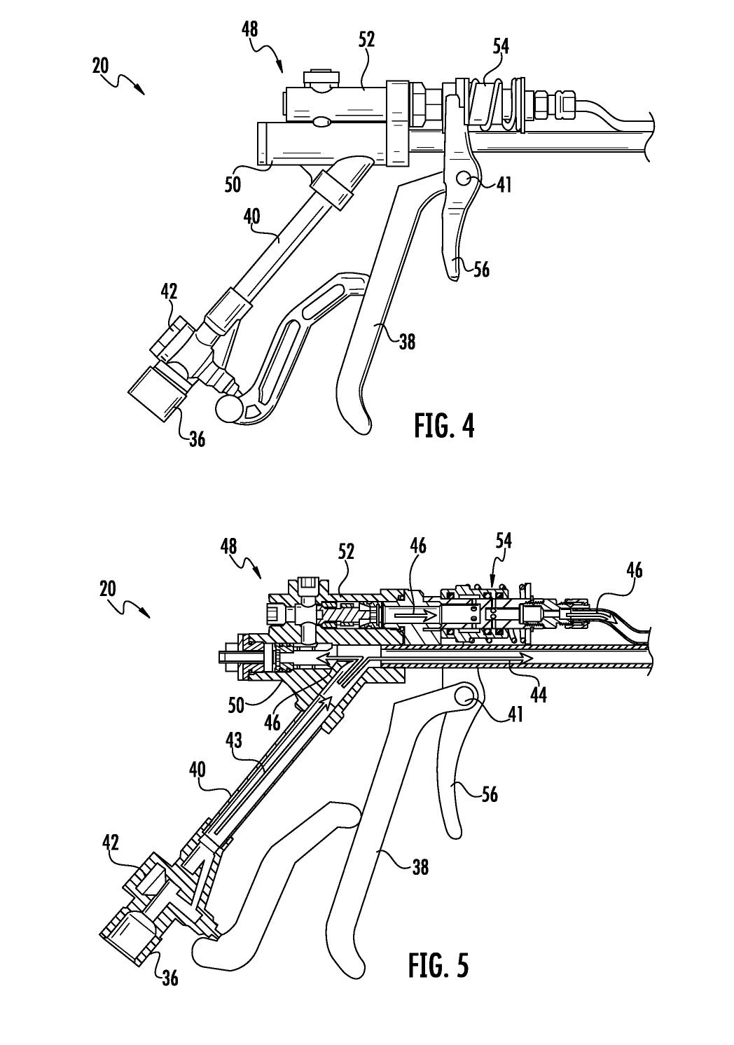

Referring now to FIGS. 4-5, the rear portion of the spray gun 20 is shown in more detail. With the flow-control valve 42 in the open position, water may flow through the conduit 40 along an inlet flow path 43. The water may continue to flow through the conduit 40 to the nozzle 34 along a primary or first flow path 44 at a first, relatively high pressure. A portion of the water flow may be diverted from the first flow path 44 to a secondary or second flow path 46. The portion of the water flow in the second flow path 46 passes through the chemical supply system 80 to selectively introduce a liquid chemical, which is introduced into the water stream formed by the water from the first flow path 44 after it has been dispensed from the nozzle 34.

Water diverted from the first flow path 44 to the second flow path 46 flows from the conduit 40 through a pressure regulator 48. The pressure regulator 48 reduces the pressure of the water in the second flow path 46 relative to the pressure of the water in the first flow path 44. According to an exemplary embodiment, the pressure regulator 48 is a two stage pressure regulator including a first valve 50, and a second valve 52. In some embodiments, the pressure regulator 48 reduces incoming water at a pressure of about 3200 pounds per square inch to about 5 pounds per square inch.

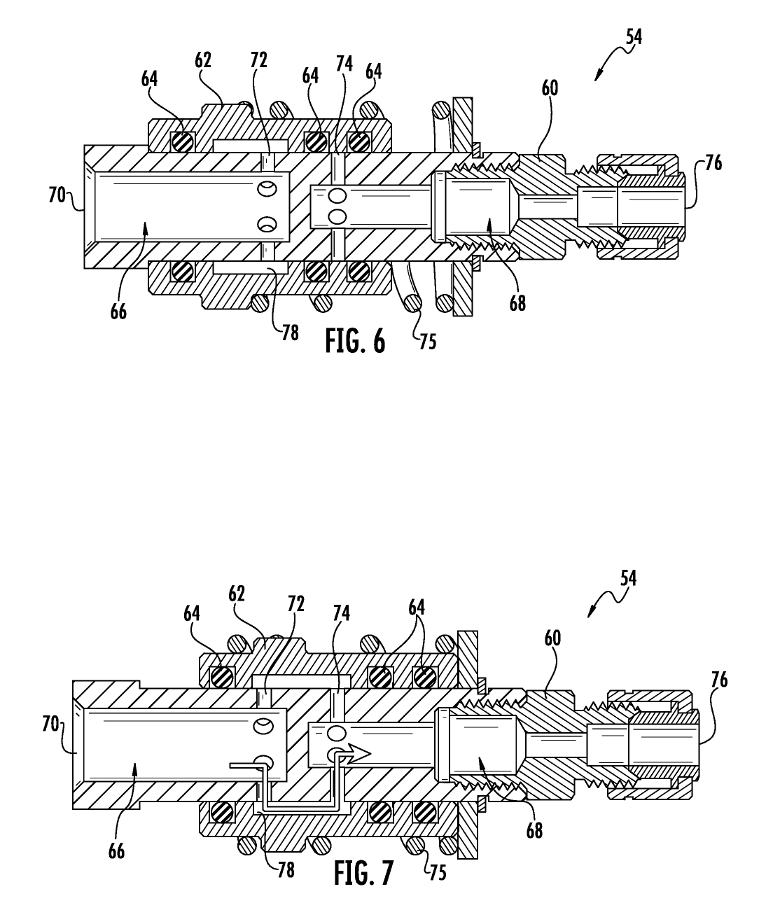

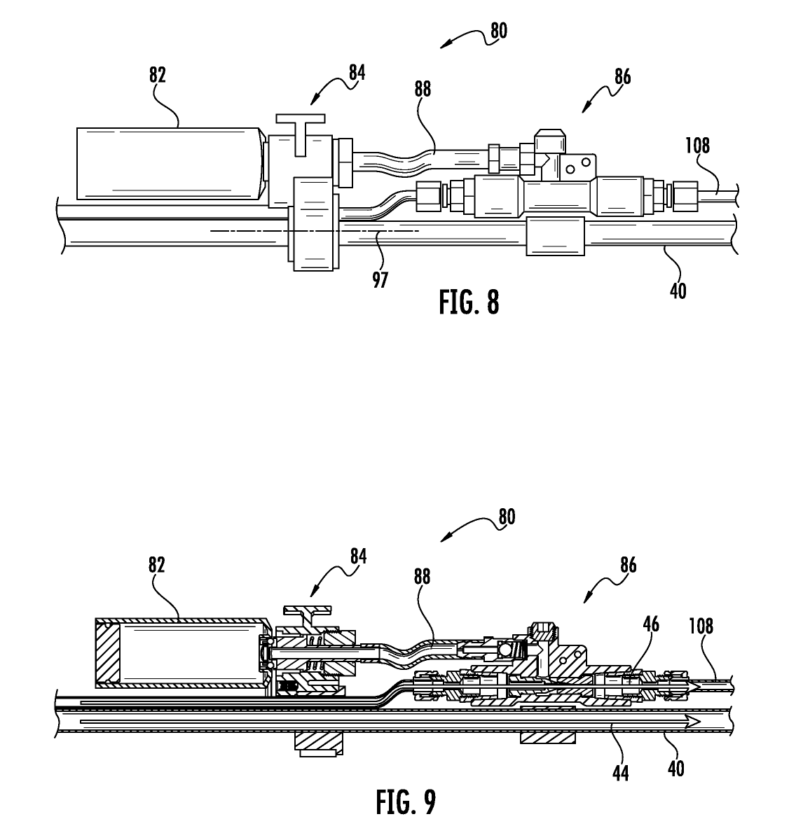

Referring now to FIGS. 6-7, upon exiting the pressure regulator 48 at the second, lower pressure, the water in the second flow path 46 passes through a flow-control valve 54. The flow-control valve 54 is coupled to and controlled by a trigger 56 (see FIG. 5). The trigger 56 is configured to pivot about the pivot 41. The flow-control valve 54 includes an inner member 60 and an outer member 62. The inner member 60 and the outer member 62 are hollow, cylindrical members with the inner member 60 nesting within the outer member 62. A sliding seal is formed between the inner member 60 and the outer member 62 with seal members, shown as O-rings 64 disposed between the inner member 60 and the outer member 62. The inner member 60 defines a first chamber 66 and a second chamber 68. The first chamber 66 includes an inlet 70 in fluid communication with the pressure regulator 48 and an outlet formed by one or more apertures 72 in the wall of the inner member 60. The second chamber 68 includes an inlet formed by one or more apertures 74 in the wall of the inner member 60 and an outlet 76. An annular chamber 78 is formed between the inner member 60 and the outer member 62. As shown in FIG. 6, in the open position, the outer member 62 is positioned such that the apertures 72 and 74 are each aligned with the annular chamber 78 such that the first chamber 66 is in fluid communication with the second chamber 68 and water may flow freely through the flow-control valve 54. As shown in FIG. 6, in the closed position, the outer member 62 is positioned such that at least one of the apertures 72 or the apertures 74 are not aligned with the annular chamber 78 such that the first chamber 66 is isolated from the second chamber 68, preventing water from flowing through the flow-control valve 54.

The outer member 62 is coupled to the trigger 56 such that, when the trigger 56 is rotated about the pivot 41, the outer member 62 moves relative to the inner member 60 between the closed position and the open position. The flow-control valve 54 is configured to be opened when the user pulls the trigger 56 towards the handle 32, allowing the water to flow through the pressure regulator 48 along the second flow path 46, and closed when the trigger 56 is released. The trigger 56 may be biased towards the closed position by a biasing element, such as a coil spring 75 biasing the flow-control valve 54 to the closed position. The trigger 56 is positioned such that a user can manipulate both the trigger 56 and the trigger 38 with one hand without moving the hand from the handle 32. The user may engage either of the trigger 38 and the trigger 56 independently or may engage both the trigger 38 and the trigger 56 simultaneously. In some embodiments, the trigger 38 and the trigger 56 may be interconnected such that the trigger 56 may only be pulled back after the trigger 38 has been pulled back (e.g., chemicals from the chemical supply system 80 may not be dispensed into the second flow path 46 unless high pressure water is flowing along the first flow path 44.

Referring now to FIGS. 8-11, the chemical supply system 80 is shown in more detail. The chemical supply system 80 includes a container, shown as a receptacle 82 containing a chemical. The receptacle 82 may contain, for example, a detergent or other solution typically used in cleaning applications. As described in more detail below, the chemical supply system 80 may be configured to dispense multiple, selectable chemicals into the water stream. The chemical supply system 80 includes a selector or selector valve 84, which allows a chosen chemical to be dispensed from a receptacle 82. The dispensed chemical flows from the receptacle 82, through the selector 84, and to a venturi pump 86 via a conduit 88. The venturi pump 86 provides a suction force to draw the chemical from the receptacle 82 when a flow path is established between the venturi pump 86 and the receptacle 82.

According to an exemplary embodiment, the conduit 88 is a flexible member, allowing the selector 84 to be moved relative to the venturi pump 86 (e.g., moved to multiple receptacles 82 containing different chemicals). For example, the conduit 88 may be a hose formed from rubber or another flexible material.

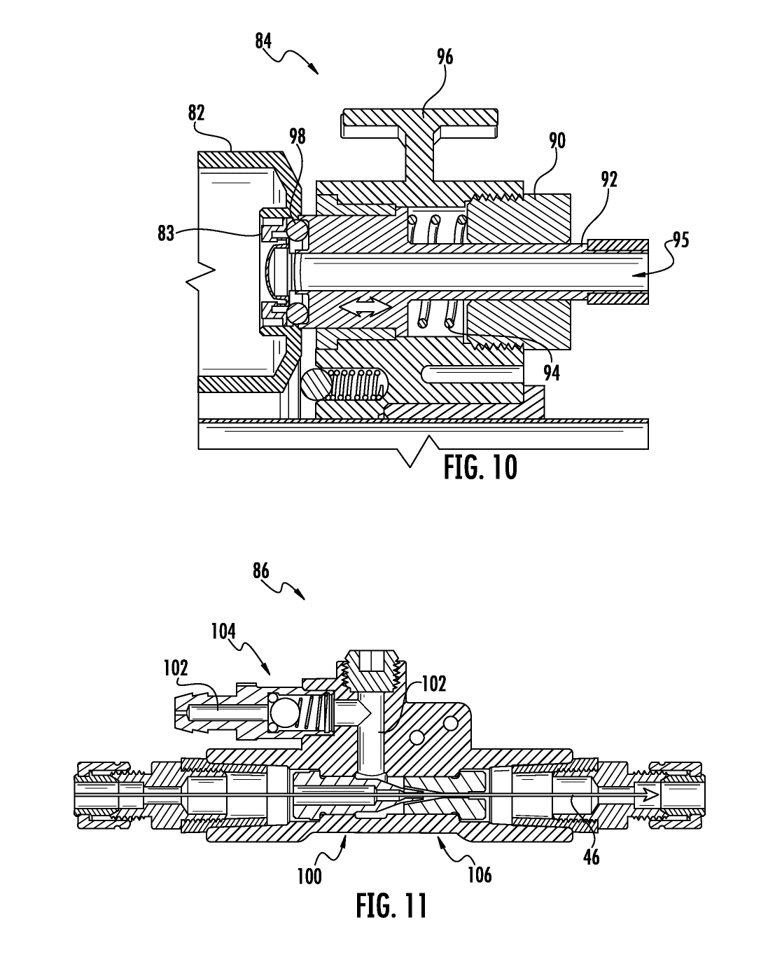

Referring to FIG. 10, the selector 84 is shown in more detail, according to an exemplary embodiment. The selector 84 may be moved by the user to bring the receptacle 82 containing a selected chemical in fluid communication with the venturi pump 86. The selector 84 includes a body 90 and a plunger 92 that is moveable relative to the body 90. The plunger 92 defines a passage 95 through which a fluid (e.g., the chemical within the receptacle 82) may flow through the selector 84. The plunger 92 is biased in a direction towards the receptacle 82 with a biasing member, shown as a coil spring 94. The selector 84 is moved into alignment with the receptacle 82 with a user interface 96, shown in FIG. 10 as a lever extending from the body 90. According to an exemplary embodiment, the interface 96 is a body that is fixed to the body 90. The body 90 is contained within the body 33 of the spray gun 20 and the user interface 96 extends through an opening in the body 33 to be accessible to the user. According to an exemplary embodiment, multiple receptacles 82 are arranged in an arc and the user can select a desired receptacle by moving the selector 84 about a longitudinal axis 97 (see FIG. 8) with the user interface 96. When the selector 84 is aligned with the receptacle 82 containing the desired chemical, the plunger 92 is forced towards the receptacle 82 by the coil spring 94. A seal is formed between the plunger 92 and the receptacle 82 with a sealing member, shown as an O-ring 98. The suction force provided by the venturi pump 86 creates a negative pressure differential between the passage 95 and the interior of the receptacle 82, which opens an orifice 83 in the receptacle 82 to open a flow path for the chemical. When the selector 84 is moved such that it is no longer aligned with the receptacle 82 (e.g., moved to be aligned with another receptacle containing another chemical), the seal formed by the O-ring 98 between the plunger 92 and the receptacle 82 is broken and the orifice 83 closes, preventing the further dispensation of the chemical from the receptacle 82. In some embodiments, the selector 84 may include a neutral position setting in which the plunger 92 is not aligned with any receptacle 82 and no chemicals are added to the water in the second flow path 46. The neutral position may be utilized, to rinse an object with water only between applications of different chemicals.

Referring to FIG. 11, the venturi pump 86 is shown in more detail, according to an exemplary embodiment. The venturi pump 86 includes a nozzle 100 through which water in the second flow path 46 passes. The nozzle 100 increases the velocity of the water in the second flow path 46 and reduces the pressure. The venturi pump 86 defines a passage 102 in fluid communication with the nozzle 100 and with the conduit 88. The chemical from the receptacle 82 is drawn from the conduit 88 through the passage 102 to the nozzle 100. A check valve 104 is provided between the passage 102 and the conduit 88 and prevents any fluids (e.g., water, chemicals, etc.) from passing back from the passage 102 to the conduit 88. After passing through the nozzle 100, the chemical and the water are mixed together in a mixing tube 106 provided downstream from the nozzle 100. The chemical and water mixture then continues along the second flow path 46 through a conduit 108 (see FIG. 8) to the nozzle 34.

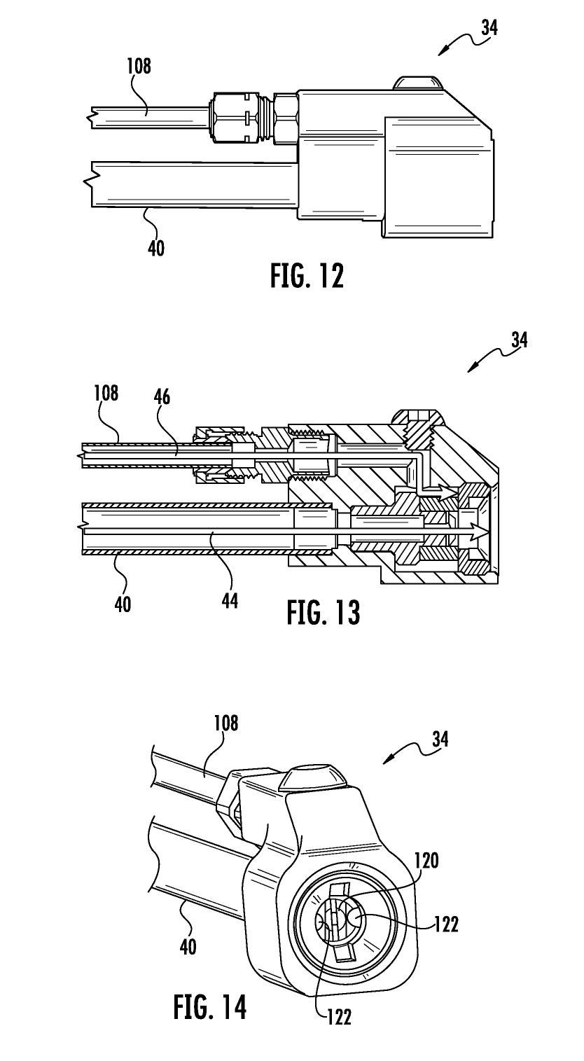

Referring now to FIGS. 12-14 the nozzle 34 is shown in more detail, according to an exemplary embodiment. Water flows along the first flow path 44 through the conduit 40 and the chemical/water mixture flows along the second flow path 46 through the conduit 108. The nozzle 34 includes a first orifice 120 through which the high pressure water of the first flow path 44 is dispensed and a second orifice 122 through which the lower pressure chemical/water mixture of the second flow path 46 is dispensed. The water of the first flow path 44 and the chemical/water mixture of the second flow path 46 are dispensed such that they mix together after exiting the nozzle 34. The chemical may be dispensed into the water in the second flow path 46 at a relatively low rate and subsequently mixed with the water of the first flow path 44 outside of the nozzle 34, allowing the chemical to be provided in a very concentrated form and the receptacles 82 to be relatively small in size.

In one embodiment, the first orifice 120 is an elongated slot that dispenses the high pressure water of the first flow path 44 in a flat, fan-shaped spray. The first orifice 120 may be configured such that the water of the first flow path 44 is dispensed in a relatively wide, dispersed spray or a relatively narrow, confined spray. According to one embodiment, the water of the first flow path 44 is dispensed from the nozzle 34 in a flat, 25 degree fan-shaped spray. While the first orifice 120 is shown in FIG. 14 to be oriented vertically to produce a vertical fan-shaped spray, in other embodiments the first orifice 120 may be otherwise oriented to provide a horizontal spray or an angled spray. In other embodiments, the orifice may be configured to dispense the water of the first flow path 44 in a different spray shapes (e.g., a narrow, confined stream, a conical stream, a pulsing stream, etc.), flow rates, and pressures.

In one embodiment, the second orifice 122 includes multiple openings provided outward from the first orifice 120. The second orifice dispenses the chemical/water mixture of the second flow path 46 inward, such that the spray from the second orifice 122 intersects with the spray from the first orifice 120.

In one embodiment, the nozzle 34 is a single nozzle providing an output stream that is applicable to various tasks (e.g., pre-washing, washing, rinsing, etc.). In some embodiments, the nozzle 34 may be a variable nozzle that is capable of producing various patterns, pressures, and flow rates for the stream of water (e.g., the nozzle 34 may include a rotatable head with multiple openings). In some embodiments, the nozzle 34 may receive one of multiple spray nozzles, each of which provide a different pattern, pressure, flow rate, etc.

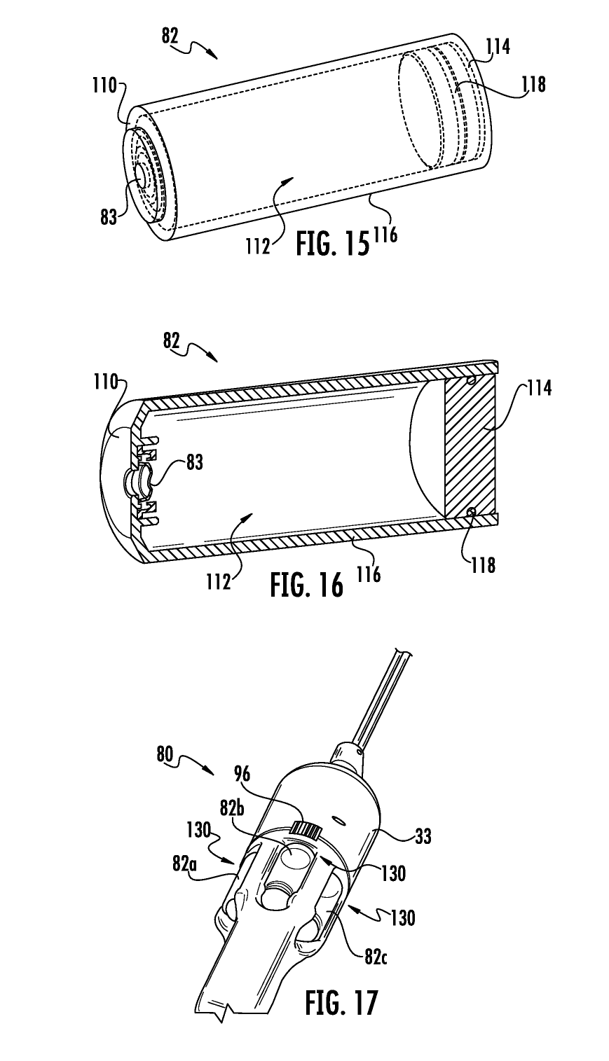

Referring now to FIGS. 15-16, the receptacles 82 of the chemical supply system 80 are shown in more detail, according to an exemplary embodiment. The receptacle 82 is shown as a hollow, cylindrical cartridge defining an interior volume 112 defining a storage volume in which a chemical may be contained. The receptacle 82 includes a sealed orifice 83 disposed on an end wall 110. According to an exemplary embodiment, the sealed orifice 83 is configured to be opened when a pre-determined force is applied (e.g., a suction force applied by the venturi pump 86) to allow the chemical to be dispensed from the interior volume 112 of the receptacle 82 and may close automatically in the absence of an outside force to seal the chemical within the receptacle 82. The orifice 83 may, for example, be formed from a resilient material. The orifices 83 in the various provided receptacles 82 may vary in properties (e.g., diameter, resilience, etc.) to meter the dispensation of the chemicals from the receptacles 82.

Preferably, the interior volume 112 of the receptacle 82 is capable of reducing in size as the chemical is dispensed, thereby maintaining a constant pressure within the interior volume 112. In one exemplary embodiment, the receptacle 82 includes a moveable member, shown as a plunger 114. The plunger 114 forms an end wall of the receptacle 82 opposite the end wall 110. The plunger 114 is moveable relative to the end wall 110. A seal is formed between the plunger 114 and the cylindrical side wall 116 of the receptacle with a sealing member, shown as an O-ring 118. As the chemical is dispensed from the receptacle 82 to be mixed with the water in the second flow path 46, the plunger 114 moves towards the end wall 110, reducing the interior volume 112 of the receptacle 82.

In other embodiments, the receptacle 82 may be maintained at a constant pressure as the chemical is dispensed by other mechanisms. For example, the receptacle 82 may include a flexible bladder in which the chemical is contained which may collapse as the chemical is dispensed. The side wall 116 may be configured to be collapsible (e.g., an “accordion” type side wall), or the receptacle 82 may include a check valve to allow air to enter the interior volume 112 as the chemical is dispensed.

The receptacles 82 may be configured to allow the user to easily monitor the level of the chemical contained within the receptacle 82. In some embodiments, the receptacle 82 may be formed at least partially from a transparent material to allow the user to view the chemical contained within the receptacle 82 and the current level of the chemical within the receptacle 82. For example, the side wall 116 may be configured with a transparent “window” or the entire side wall 116 may be transparent.

The receptacles 82 may be configured to allow the user to easily ascertain the identity of the chemical contained within the receptacle 82. For example, the chemical contained within the receptacle 82 may be identified with a text label, a graphic, a number, or with color-coding. If the receptacles 82 are formed from transparent materials, the chemicals themselves may be color-coded. The receptacles 82 may be configured to be arranged such that they are used in order for a specific task. A group of receptacles 82 containing chemicals for a specific task may be provided to the user as a package.

The receptacles 82 may be one-time use (e.g., disposable) cartridges. In other embodiments, the receptacles 82 may be refillable. Each receptacle 82 may be configured to contain a pre-defined amount of the chemical. For example, the receptacles 82 may be configured to contain enough chemicals for a pre-defined period of use (e.g., 30 minutes, 1 hour, 2 hours) or for a pre-defined number of tasks (e.g., enough to wash one large vehicle, two average-sized vehicles, etc.). The receptacles 82 may include indicia to indicate to the user how much of the chemical remains in the receptacle.

The chemicals in different receptacles 82 may vary in concentration. For example, two chemicals may be configured to be used concurrently for the same task with the first chemical being configured to be used for a short period of time and the second chemical being configured to be used for a longer period of time. The first chemical may be relatively low in concentration and may be dispensed from its receptacle 82 relatively quickly. The second chemical may be relatively high in concentration and may be dispensed from its receptacle 82 more slowly.

Referring to FIG. 17, an exemplary chemical supply system 80 is shown to include three receptacles 82, with each of the receptacles 82 containing a different chemical. According to an exemplary embodiment, the receptacles 82 contain chemicals for use in washing a vehicle. For example, a first receptacle 82a contains a pre-soak chemical, a second receptacle 82b contains a detergent, and a third receptacle 82c contains a spot free rinse chemical. In other embodiments, the chemical supply system 80 may include fewer than three receptacles 82 or more than three receptacles 82.

The receptacles 82 are received in hollows 130 in the body 33 of the spray gun 20 and are recessed to reduce the likelihood that they will be inadvertently jarred loose during use of the spray gun 20. The receptacles 82 do not engage the body 33 of the spray gun 20, such as with threaded connections or locking lugs, allowing the user to easily change the receptacles 82. In some embodiments, each of the hollows 130 and each of the receptacles 82 are identical in size. In other embodiments, the hollows 130 may be differently sized and may be configured to receive differently sized receptacles 82.

The user may select which chemical to use by moving the selector 84 to the desired receptacle 82 by engaging the user interface 96 with the hand grasping the body 33. In this way, the user may sequentially go about a specific cleaning operation involving different chemical solutions and rinse cycles without needing to put down the spray gun 20 or return to the pressure washer.

The user interface 96 provides a tactile and visual indicator to the user of the receptacle 82 from which chemicals are being dispensed. In one exemplary embodiment, the user interface 96 is raised above the surface of the body 33 to provide a tactile indicator to the user, allowing the user to change between chemicals without looking at the spray gun 20. In other embodiments, the user interface may be differently colored than the body 33 to provide an additional visual indicator to the user.

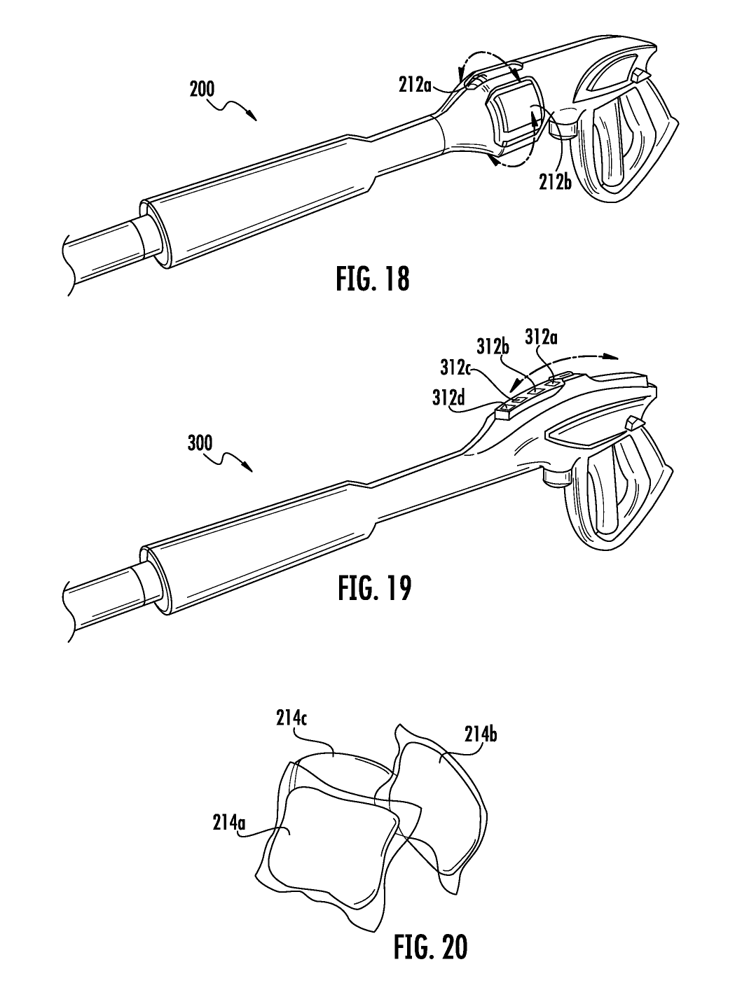

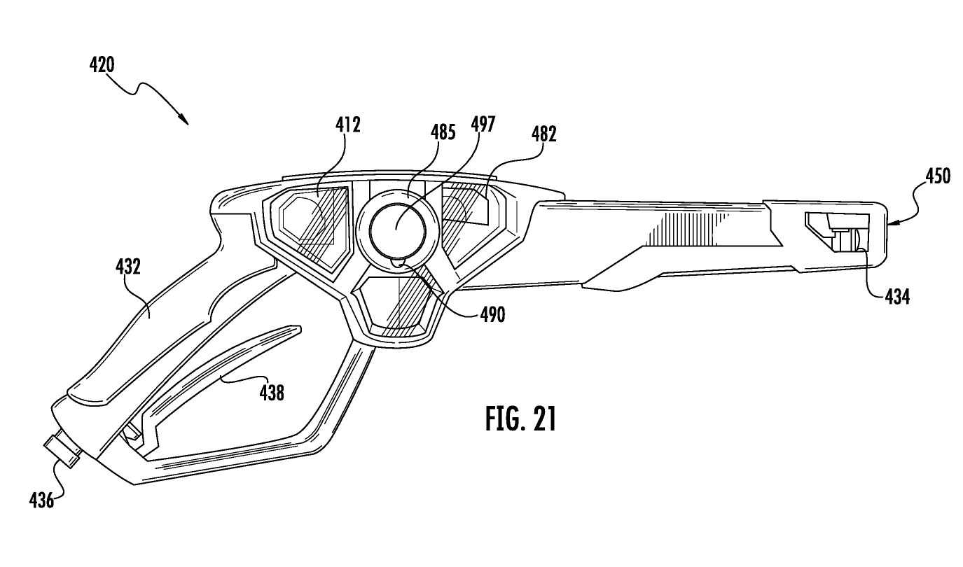

Referring now to FIGS. 18-20, a spray gun 200 is shown according to another exemplary embodiment. The spray gun 200 includes one or more chemical pack receptacles, shown as receptacles 212a and 212b. The receptacles 212a and 212b are configured to receive respective chemical-filled packs. FIG. 20 shows an example of such chemical-filled packs 214a, 214b, and 214c. In accordance with one embodiment, the receptacles 212 each include a translucent member (e.g., a cover) to allow the user to see the packs 214 contained within, along with the level of chemical remaining in each pack 214 during operation.

The user may rotate the portion of spray gun housing the receptacles 212 (the selector valve) radially about the longitudinal axis of spray gun 200 such that the chemical to be injected into a high-pressure water spray may easily be selected by the user. The chemical within the selected pack 214 is mixed with a pressurized water flow flowing along a flow path through the spray gun. In one embodiment, the chemical may be added to the stream of pressurized water indirectly (e.g., using a venturi pump) as described above. In another embodiment, rotating the portion of the spray gun 200 housing the receptacles 212 brings a selected receptacle directly into the flow path. Pressurized water flowing through the spray gun passes through the selected chemical pack receptacle 212 prior to exiting the end nozzle such that a metered amount of chemical solution is injected into the pressurized spray for use when cleaning. The interface between the inlet of the receptacle 212 and the portion of the spray gun 200 defining the flow path of the pressurized water (e.g., an internal channel or conduit) is sealed with a sealing member to direct the water into the receptacle 212 and prevent the escape of the pressurized water. Likewise, the interface of an outlet of the receptacle 212 and the portion of the spray gun defining the flow path between the receptacle 212 and the nozzle is likewise sealed.

The user may rotate the portion of the spray gun 200 housing the receptacles 212 so select a different receptacle such that a multi-chemical cleaning operation is possible without the need to change solutions at the pressure washer or change chemical bottles attached to the gun. Additionally, the rotation operation of the receptacles 212 may also include non-chemical portions to enable water-only cleaning or rinsing cycles. In this way, the user may sequentially go about a specific cleaning operation involving different chemical solutions and rinse cycles without needing to put down the spray gun 200 or return to the pressure washer. For example, during a car-washing application, the user may rotate or toggle between an initial pre-soak step using a first chemical pack, a soaping step using a second chemical pack, a rinsing step using no chemical pack, a wax step using a third chemical pack, and a final spot-free rinse step using no chemical pack again. Of course, other pressure washing applications involving multiple chemical solutions are also possible under the exemplary embodiment.

Referring to FIG. 19, an alternative exemplary embodiment is shown. The spray gun 300 includes many of the same features as the spray gun 200 discussed above with respect to FIG. 18. Unlike the spray gun 200, the spray gun 300 does not utilize rotatable receptacles to enable the user to switch between various chemicals or chemical packets. Instead, the spray gun 300 includes multiple chemical receptacles 312a, 312b, 312c, 312d that are configured to be slidable along a longitudinal axis of spray gun 300 to enable chemical selection by the user (the selector valve). The chemical packets or solutions within the respective receptacles 312 are preferably color-coded to allow the user to identify the chemical to be used, and more or fewer receptacles are possible. As with the system discussed above, it is also envisioned that the cleaning operation utilizing slidable receptacles may also incorporate water-only rinse cycles before, between, or after chemical injection cycles.

Referring again to FIG. 20, the packs 214a, 214b, and 214c may be filled with various detergents or other solutions typically used in cleaning applications. The packs 214a, 214b, and 214c ideally contain different chemical solutions and may be color-coded to reflect the type of chemical contained therein. While the packs 214a, 214b, and 214c may be filled with a liquid chemical, a powder, a solid tablet, gel, semi-solid, or non-liquid forms of chemical are also possible. The pack itself may be configured to degrade or dissolve when in contact with water, releasing a chemical solution as it dissolves. Alternatively, the pack may be configured to be punctured such that the chemical solution is released at the point of puncture. For tablets, gels, etc., no additional outer layer would be provided on the pack.

Referring now to FIGS. 21-24, an alternative exemplary embodiment of the spray gun is shown. The spray gun 420 includes a handle 432 and a nozzle 434 positioned at an outlet 450 of the spray gun 420. In some embodiments, the spray gun 420 includes a spray wand positioned between the outlet 450 and the end of the gun 420. High pressure water is provided to the spray gun 420 from the pump outlet 30 through the delivery conduit 440, which is coupled to the spray gun 420 via an inlet 436. The inlet 436 may be a threaded fitting, such as a high-pressure fitting (e.g., an M22 fitting). The stream of water output from the nozzle 434 can be started or stopped by a user actuating a trigger 438 or other user input device.

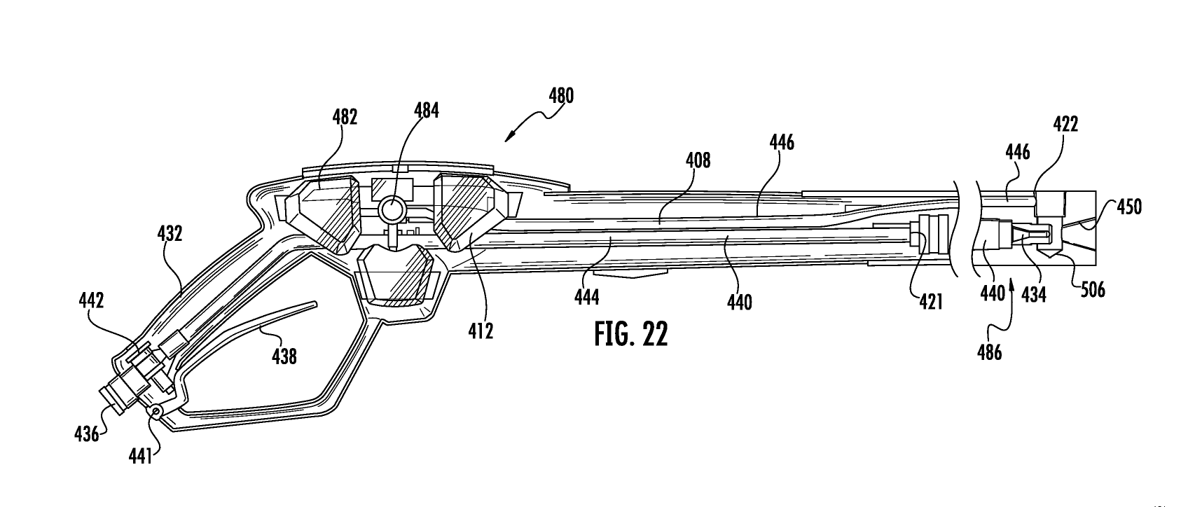

Referring now to FIG. 22, the internal components of the spray gun 420 are shown according to an exemplary embodiment. The water passes from the inlet 436 to the nozzle 434 through an internal conduit 440. The passage of water is controlled by a flow-control valve 442 that is coupled to and controlled by the trigger 438 or other user input device (e.g., trigger, button, switch, dial, touch screen, etc.). The trigger 438 is configured to pivot about a pivot point 441. The flow-control valve 442 is configured to be opened when the user pulls the trigger 438 towards the handle 432, allowing the water to flow through the conduit 440 to be expelled through the nozzle 434, and closed when the trigger 438 is released. The trigger 438 may be biased towards the closed position by a biasing element, such as a torsion spring. The spray gun 420 may further include a locking device to prevent the trigger 438 from being inadvertently pulled.

The spray gun 420 further includes a chemical supply system 480 that is configured to selectively introduce chemicals into a secondary flow path 446. The chemical supply system 480 includes multiple containers, shown as chemical tanks 482, each containing a different chemical. The tanks 482 may contain, for example, a detergent, pre-soak, rinse, car wax or other chemical solutions typically applied in a mixture with water. The chemical supply system 480 includes a selector valve 484, which allows a chosen chemical to be dispensed from a tank 482. The dispensed chemical flows from the tank 482, through the selector valve 484, and into the secondary flow path 446.

The chemical tanks 482 are shown as hollow containers defining an interior volume 412 defining a storage volume in which a chemical may be contained. In an exemplary chemical supply system 480, three chemical tanks 482 are provided, with each of the tanks 482 containing a different chemical. According to an exemplary embodiment, the tanks 482 contain chemicals for use in washing a vehicle. For example, a first tank 482a contains a pre-soak chemical, a second tank 482b contains a detergent, and a third tank 482c contains a spot free rinse chemical. In other embodiments, the chemical supply system 480 may include fewer than three tanks 482 or more than three tanks 482. In some embodiments, the fluid in the tanks 482 is maintained at a substantially constant pressure as the chemical is dispensed from the tanks. For example, the tanks 482 may include a flexible bladder in which the chemical is contained which may collapse as the chemical is dispensed. Alternatively, the tanks 482 may include a check valve to allow air to enter the tank 482 as the chemical is dispensed, with the air taking the place of the displaced chemical.

The tanks 482 are secured within chambers 430 formed in the spray gun housing 433. In some embodiments, each of the chambers 430 and each of the tanks 482 are identical in size. In other embodiments, the chambers 430 may be differently sized and may be configured to secure differently sized tanks 482. The tanks 482 may be configured to allow the user to easily monitor the level of the chemical contained within the tank 482. In some embodiments, the tank 482 may be formed at least partially from a transparent material to allow the user to view the chemical contained within the tank 482 and the current level of the chemical within the tank 482. For example, the tanks 482 may be configured with a transparent “window”. The tanks 482 may be configured to allow the user to easily ascertain the identity of the chemical contained within the tank 482. For example, the chemical contained within the tank 482 may be identified with a text label, a graphic, a number, or with color-coding. If the tanks 482 are formed from transparent materials, the chemicals themselves may be color-coded. The tanks 482 may be configured to be arranged such that they are used in order for a specific task. For example, the tanks 482 or the housing near the tanks 482 may be labeled with text labels, including numerical indicia to indicate the order in which the tanks 482 are used for a specific task. A group of tanks 482 containing chemicals for a specific task may be provided to the user as a package. The tanks 482 may be refillable. Each tank 482 may be configured to contain a pre-defined amount of the chemical. For example, the tanks 482 may be configured to contain enough chemicals for a pre-defined period of use (e.g., 30 minutes, 1 hour, 2 hours) or for a pre-defined number of tasks (e.g., enough to wash one large vehicle, two average-sized vehicles, etc.). The tanks 482 are sized to hold 2 ounces (oz) (59 milliliters (mL)) of fluid. In other embodiments, the tanks 482 can range in size from 1 oz (30 mL) to 8 oz (237 mL), or other sizes appropriate for the desired end use. The tanks 482 may include indicia to indicate to the user how much of the chemical remains in the receptacle. In some embodiments, to refill the tanks 482, the user unscrews, removes, etc., a cap positioned on the tanks 482 and replenishes the chemical held within the each tank without removing the tanks 482 from the spray gun body. In other embodiments, the tanks 482 are removable and can either be exchanged for new filled tanks or refilled and reused. Removable tanks may include a normally-closed valve to prevent unwanted leakage of chemicals from the tank. Removable tanks or the associated tank receptacle in the housing may include an O-ring, gasket, or other seal to inhibit chemical leaks at the interface between the tank and the housing.

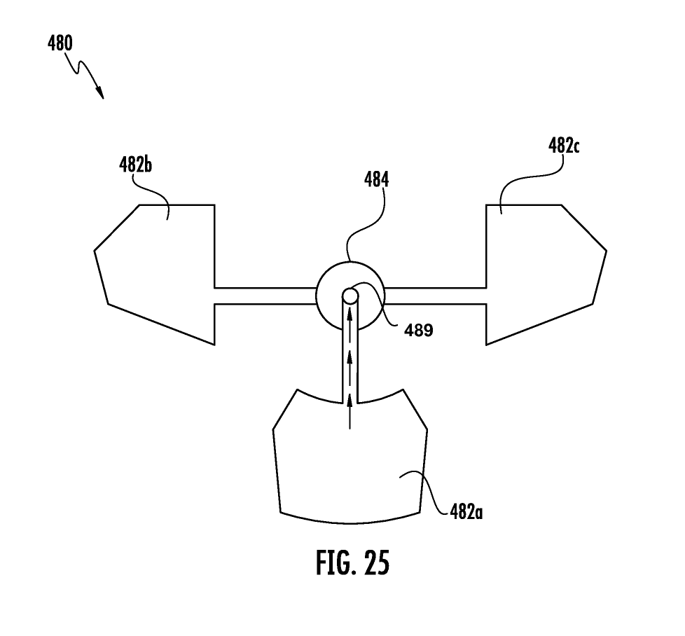

Referring to FIG. 21, a selector knob or user interface device 485 is coupled to the selector valve 484 to allow a user to rotate the selector valve 484 and control the position of the selector valve 484. The selector knob 485 may be moved by the user to bring a chemical tank 482 containing a selected chemical in fluid communication with the secondary flow path 446. The selector valve 484 defines a passage 489 (shown in FIGS. 25-27) through which a fluid (e.g., the chemical within the tank 482) may flow through the selector valve 484. The selector knob 484 includes a marker 490 that indicates to the user which chemical tank 482 is selected. The selector valve 484 is moved into alignment with the tank 482 by the user rotating the selector knob 485 until the marker 490 is aligned with the desired tank 482. According to an exemplary embodiment, multiple tanks 482 are arranged radially around the selector valve 484 and the user can select a desired receptacle by moving the selector knob 485 about an orthogonal axis 497 of the knob 485. When the selector knob 485 is aligned with the tank 482 containing the desired chemical, the suction force provided by the venturi 486, due to flow of high pressure water past passage 502, creates a negative pressure differential between the mixing chamber 506 of the venturi 486 described further herein, and the interior of the tank 482, which pulls the chemical out of the tank 482 and into the secondary flow path 446 toward the outlet 450 of the spray gun 420. When the selector knob 485 is moved such that it is no longer aligned with the tank 482 (e.g., moved to be aligned with another tank containing another chemical), the chemical in the tank 482 is no longer in fluid communication with the secondary flow path 446 and venturi 486. In some embodiments, the selector knob 485 includes a neutral position (e.g., off position) setting in which the selector valve 484 is not aligned with any tank 482 and no chemicals are supplied to the secondary flow path 446. The neutral position may be utilized to rinse an object with water only between applications of different chemicals and to rinse any remaining chemicals from the secondary flow path 446.

Water flows along the primary flow path 444 at a relatively high pressure through the conduit 440 and a selected chemical flows along the secondary flow path 446 at a relatively low pressure through the conduit 408. The nozzle 434 includes a first orifice 421 through which the high pressure water of the primary flow path 444 is dispensed and a second orifice 422 through which the lower pressure chemical of the secondary flow path 446 is dispensed. The water of the primary flow path 444 and the chemical of the secondary flow path 446 are mixed together at a venturi 486 downstream of the nozzle 434.

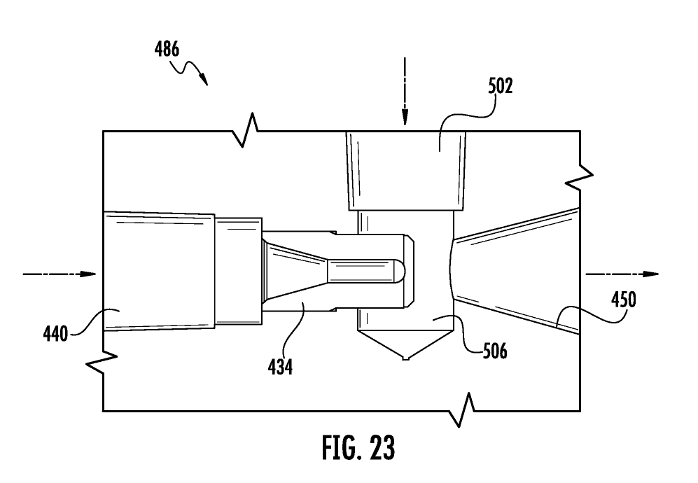

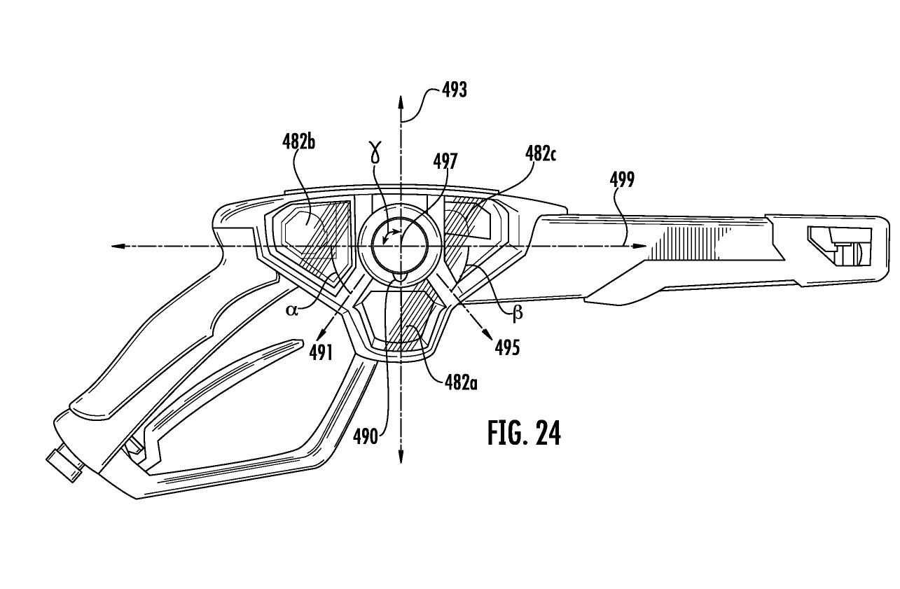

Referring to FIG. 23, the venturi 486 is positioned proximate the outlet 450 of the spray gun 420. In some embodiments, the venturi 486 is located within 3 inches of the outlet 450. The primary fluid flow path 444 and the secondary flow path 446 are selectively combined in a mixing chamber 506 located upstream of the outlet 450. The venturi 486 provides suction to draw the chemical from one of the tanks 482 when a flow path is established between the venturi 486 and a selected tank 482 (e.g., via the secondary flow path 446 and selector valve 484). The venturi 486 includes the nozzle 434 through which water in the primary flow path 444 passes. The nozzle 434 increases the velocity of the water in the primary flow path 444 and reduces the pressure before discharging the water into the mixing chamber 506. The venturi 486 defines a passage 502 in fluid communication with the mixing chamber 506 and with the conduit 408. The chemical from the tank 482 is drawn from the conduit 408 through the passage 502 to the nozzle 434. In some embodiments, a check valve is provided between the passage 502 and the conduit 408 and prevents any fluids (e.g., water, chemicals) from passing back from the passage 502 to the conduit 408. In some embodiments, in addition to the check valve, a manually actuated chemical shutoff valve is provided shut that a user can selectively shut off the flow from the secondary flow path 444 from entering the venturi 486. After passing through the nozzle 434, the chemical and the water are mixed together in the mixing chamber 506. The chemical and water mixture then exits the outlet 450 of the spray gun 420.

The pressure differential between the mixing chamber 506 and the chemical tanks 482 can be changed by changing the effective flow area of the outlet 450 and thereby changing the backpressure at the venturi 486. In some embodiments, the outlet 450 is configured to receive one of a number of spray nozzles with each nozzle providing a different output pressure and/or a different water spray pattern for the output fluid flow so that the selected nozzle provides the final fluid output from the spray gun 420. In some embodiments, the outlet 450 and the spray nozzles have a quick-connect or other fluid coupling interface to allow the user to selectively attach a nozzle to the outlet 450. In other embodiments, the outlet is formed in a rotatable turret, where the turret includes a number of outlets, each configured to provide a different output pressure and/or a different water spray pattern for the output fluid flow so that the selected nozzle provides the final fluid output from the spray gun 420. In one embodiment, the spray nozzle includes a 30 degree spray angle. In other embodiments, the spray nozzle spray angle can range between a 20 degree spray angle and a 50 degree spray angle. In some embodiments, the spray pattern emitted from the spray nozzles can include a straight spray or a flat fan spray. The user rotates the turret to move one of the outlets into the proper position to function as the outlet of the spray gun. In some embodiments, certain higher pressure nozzles create a backpressure at the venturi 486 that exceeds a threshold pressure and prevents the venturi 486 from operating to pull in the chemicals from the secondary flow path 446. In other embodiments, certain higher flow nozzles create a backpressure at the venturi 486 below the threshold pressure and allow the venturi 486 to operate to pull in chemicals from the secondary flow path 446 into mixing chamber 506 to be mixed with the water from the primary flow path 440. The user is able to switch between tasks directly at the spray gun, using a flow control valve to start and stop the fluid flow as needed and changing the nozzle to select the appropriate operating and chemical mode, rather than having to make a change at the body of the pressure washer. This can simplify the process of changing between tasks and reduce the time needed to switch between tasks (e.g., pressure washing, rinsing, flushing, soaping, spot-free rinsing, etc.).

Referring to FIG. 24, the selector knob 485 is shown, along with multiple positions to which a user can move the selector knob 485. As shown, the selector knob 485 is circular in shape. In other embodiments, the selector knob 485 can be square, rectangular, or various other shapes. The selector knob 485 can be rotated in a full circle (e.g., 360 degrees) such that the marker 490 of the selector knob 485 can be in a first position (e.g., selecting a first chemical tank 482a as shown), and be rotated through a second position (e.g., selecting a second chemical tank 482b), to a third position (e.g., selecting a third chemical tank 482c), and back to the first position. In some embodiments, the selector knob 485 can rotate either clock-wise or counter-clock-wise. In some embodiments, detents at the chemical tanks 482 and the neutral positions allow the user to know when the selector valve 484 is engaged with the selected tank or neutral position.

The selector knob 485 may also be rotated to a neutral position such that no chemicals are in fluid communication with the secondary flow path 446. As shown in FIG. 24, in some embodiments, multiple neutral positions (e.g., neutral positions 491, 493, 495) may be included. The neutral positions are positioned in between the tank positions (e.g., first position, second position, third position). For example, a first neutral position 491 is positioned between the first position selecting tank 482a and the second position selecting tank 482b, the second neutral position 493 is positioned between the second position selecting tank 482b and the third position selecting tank 482c, and the third neutral position 495 is positioned between the third position selecting tank 482c and the first position selecting tank 482a. The neutral positions are located at an angle from each tank position. As such, the first neutral position 491 is positioned an angle α from the first tank position, the second neutral position 493 is positioned an angle β from the second tank position, and the third neutral position 493 is position an angle γ from the third tank position. In some embodiments, angles α and β are 45 degrees. In other embodiments, angles α and β are more or less than 45 degrees. In some embodiments, angle γ is 90 degrees. In other embodiments, angle γ is more or less than 90 degrees. In some embodiments, neutral position 493 is the only neutral position included with the spray gun 420. In other embodiments, one or two of the neutral positions 491, 493, 495 are included with the spray gun 420.

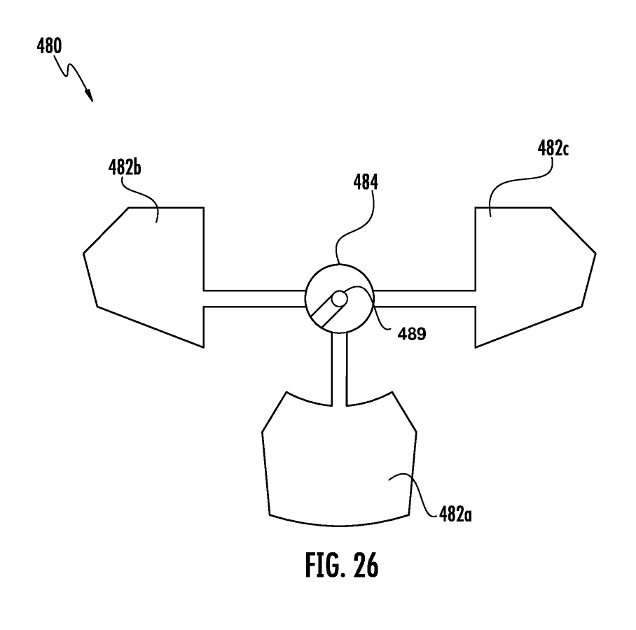

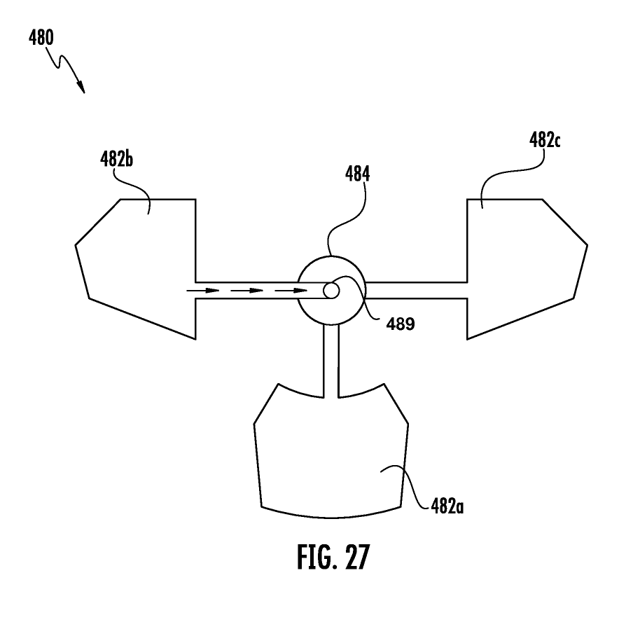

Referring to FIGS. 25-27, in a first position (shown in FIG. 25) the selector valve 484 allows the first chemical tank 482a to be in fluid communication with the secondary flow path 446. A chemical from the first chemical tank 482a flows through the selector valve 484 (e.g., due to the pressure differential between the mixing chamber 506 and the interior of the first chemical tank 482a), into the secondary flow path 446 and to the venturi 486 for mixing with pressurized water from the primary flow path 440. As shown in FIG. 26, the selector knob 485 can be rotated to bring the selector valve 484 to the first neutral position positioned between the first chemical tank 482a and the second chemical tank 482b (e.g., first neutral position 491 shown in FIG. 24) such that no chemicals are in fluid communication with the secondary flow path 446. As shown in FIG. 27, the selector valve 484 is shown in a second position such that the selector valve 484 allows the second chemical tank 482b to be in fluid communication with the secondary flow path 446. A chemical from the second chemical tank 482b flows through the selector valve 484 (e.g., due to the pressure differential between the mixing chamber 506 and the interior of the second chemical tank 482b), into the secondary flow path 446 and to the venturi 486 for mixing with the pressurized water from the primary flow path 440. A similar arrangement can be used to achieve second and third neutral positions 493, 495 as described above, and to achieve the third position (e.g., bringing the third chemical tank 482c in fluid communication with the secondary flow path 446).

The user may rotate the selector knob 485 to select a different chemical tank such that a multi-chemical cleaning operation is possible without the need to change solutions at the pressure washer or change chemical bottles attached to the spray gun. As noted above, the rotation of the selector knob 485 may include neutral (e.g., non-chemical) positions to enable water-only cleaning or rinsing cycles. By providing the chemical tanks 482 and the selector valve 484 on the spray gun 420, the user may sequentially go about a specific cleaning operation involving different chemical solutions and rinse cycles without needing to put down the spray gun or return to the pressure washer to change out chemical tanks or switch between chemical tanks. For example, during a car-washing application, the user may rotate or toggle between an initial pre-soak step using a first chemical tank, a soaping step using a second chemical tank, a rinsing step using no chemicals (e.g., selecting second neutral position 493), a wax step using a third chemical tank, and a final spot-free rinse step using no chemicals again (e.g., selecting third neutral position 495).

As utilized herein, the terms “approximately,” “about,” “proximate,” “substantially,” and similar terms are intended to have a broad meaning in harmony with the common and accepted usage by those of ordinary skill in the art to which the subject matter of this disclosure pertains. These terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “exemplary” as used herein to describe various embodiments is intended to indicate that such embodiments are possible examples, representations, and/or illustrations of possible embodiments.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the accompanying drawings. The orientation of various elements may differ according to other exemplary embodiments, and that such variations are intended to be encompassed by the present disclosure.

The construction and arrangement of the pressure washer as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

1. A spray gun for use with a pressure washer, comprising:
a spray gun body;
an inlet;
a primary flow path for conducting a primary fluid flow;
a secondary flow path for conducting a secondary fluid flow;
an inlet flow path for receiving a flow of pressurized water from the pressure washer via the inlet, the inlet flow path directing the pressurized water into the primary flow path;
a plurality of chemical containers carried on the spray gun body; and
a selector valve movable among a plurality of positions to fluidly couple one of the plurality of chemical containers with the secondary flow path.

2. The spray gun of claim 1, wherein the plurality of positions comprises:
a first position, wherein when the selector valve is in the first position, a first chemical container is fluidly coupled to the secondary flow path; and
an off position, wherein when the selector valve is in the off position, no chemical container is fluidly coupled to the secondary flow path.

3. The spray gun of claim 2, wherein the plurality of positions further comprises:
a second position, wherein when the selector valve is in the second position, a second chemical container is fluidly coupled to the secondary flow path;
wherein the off position is positioned between the first position and the second position.

4. The spray gun of claim 2, wherein the plurality of positions comprises:
a first position, wherein when the selector valve is in the first position, a first chemical container is fluidly coupled to the secondary flow path;
a second position, wherein when the selector valve is in the second position, a second chemical container is fluidly coupled to the secondary flow path;
a first off position positioned between the first position and the second position, wherein when the selector valve is in the first off position, no chemical container is fluidly coupled to the secondary flow path;
a third position, wherein when the selector valve is in the third position, a third chemical container is fluidly coupled to the secondary flow path,
a second off position positioned between the second position and the third position, wherein when the selector valve is in the second off position, no chemical container is fluidly coupled to the secondary flow path.

5. The spray gun of claim 4, wherein the plurality of chemical containers are radially positioned about an axis of rotation of the selector valve.

6. The spray gun of claim 5, wherein the selector valve is turned 90 degrees to move between the first position and the second position.

7. The spray gun of claim 6, wherein the selector valve is turned 45 degrees to move between the first position and the first off position.

8. The spray gun of claim 1, wherein the plurality of chemical containers are arranged in a specific order to perform a specific task when selected by the selector valve in the specific order.

9. The spray gun of claim 8, wherein the plurality of chemical containers includes three containers, a first container containing a pre-soak chemical, a second container containing soap, and a third container containing a spot-free rinse chemical, and the three containers are arranged in a numerical order to wash a car when selected by the user in numerical order.

10. The spray gun of claim 1, further comprising a venturi comprising:
a mixing chamber;
a nozzle including a primary flow path outlet where the primary fluid flow exits the primary flow path to the mixing chamber;
a secondary flow path outlet where the secondary fluid flow exits the secondary flow path to the mixing chamber; and
an outlet fluidly coupled to the mixing chamber.

11. The spray gun of claim 1, further comprising:
a first trigger for actuation by the user;
a first flow-control valve coupled to the first trigger for controlling the primary fluid flow through the primary flow path;
a second trigger for actuation by the user; and
a second flow-control valve coupled to the second trigger for controlling the secondary fluid flow through the secondary flow path.

12. The spray gun of claim 11, wherein the lever is arranged for actuation by the thumb of the user's hand and the first trigger and the second trigger are arranged for actuation by the fingers of the user's hand.

13. The spray gun of claim 1, wherein each of the plurality of containers includes a refillable chemical tank.

14. The spray gun of claim 1, further comprising a plurality of indicia, each indicia associated with one of the plurality of chemical containers, wherein each indicia indicates one of a first chemical, a second chemical, and a third chemical.

15-21. (canceled)

22. A spray gun for use with a pressure washer, comprising:
a spray gun body;
a plurality of chemical containers carried on the spray gun body; and
a selector valve configured to select one of the plurality of chemical containers to fluidly couple a selected container to an outlet of the spray gun.

23. A method of completing a cleaning cycle using a spray gun, comprising:
selecting from a plurality of chemical containers arranged in a numerical order to complete a specific task when selected in a specific order, comprising:
selecting, by a selector valve, a first chemical container containing a first chemical; dispensing the first chemical from the spray gun;
selecting, by the selector valve, a second chemical container containing a second chemical;
dispensing the second chemical from the spray gun;
selecting, by the selector valve, a third chemical container containing a third chemical; and
dispensing the third chemical from the spray gun;
wherein the plurality of chemical containers are carried on a spray gun body.

24. The method of claim 23, wherein the first chemical includes a pre-soak chemical, the second chemical includes a soap, and the third chemical includes a spot-free rinse chemical.

25. A system for use with a spray gun, comprising:
a body;
an inlet;
a primary flow path for conducting a primary fluid flow;
a secondary flow path for conducting a secondary fluid flow;
an inlet flow path for receiving a flow of pressurized water from the pressure washer via the inlet, the inlet flow path directing the pressurized water into the primary flow path;
a plurality of chemical containers carried on the body; and
a selector valve movable among a plurality of positions to fluidly couple one of the plurality of chemical containers with the secondary flow path.

26. The system of claim 25, further comprising a wand.

27. The system of claim 26, further comprising a nozzle.

28. The system of claim 25, wherein the plurality of positions comprises:
a first position, wherein when the selector valve is in the first position, a first chemical container is fluidly coupled to the secondary flow path; and
an off position, wherein when the selector valve is in the off position, no chemical container is fluidly coupled to the secondary flow path.

29. The system of claim 28, wherein the plurality of positions further comprises:
a second position, wherein when the selector valve is in the second position, a second chemical container is fluidly coupled to the secondary flow path;
wherein the off position is positioned between the first position and the second position.

30. The system of claim 28, wherein the plurality of positions comprises:
a first position, wherein when the selector valve is in the first position, a first chemical container is fluidly coupled to the secondary flow path;
a second position, wherein when the selector valve is in the second position, a second chemical container is fluidly coupled to the secondary flow path;
a first off position positioned between the first position and the second position, wherein when the selector valve is in the first off position, no chemical container is fluidly coupled to the secondary flow path;
a third position, wherein when the selector valve is in the third position, a third chemical container is fluidly coupled to the secondary flow path; and
a second off position positioned between the second position and the third position, wherein when the selector valve is in the second off position, no chemical container is fluidly coupled to the secondary flow path.

31. The system of claim 30, wherein the plurality of chemical containers are radially positioned about an axis of rotation of the selector valve.
